(19) United States
(12) Patent Application Publication
(10) Pub. No.: US 2017/0070579 A1
(43) Pub. Date: Mar. 9, 2017

(54) MECHANISM FOR FACILITATING PROXY USER INTERFACE-BASED REMOTE MANAGEMENT AND CONTROL OF COMPUTING AND NON-COMPUTING DEVICES

(71) Applicant: INTEL CORPORATION, SANTA CLARA, CA (US)

(72) Inventors: Saurabh DADU, Tigard, OR (US); GYAN PRAKASH, Beaverton, OR (US); RAVIKIRAN CHUKKA, Beaverton, OR (US); RAJESH POORNACHANDRAN, Portland, OR (US)

(73) Assignee: INTEL CORPORATION, SANTA CLARA, CA (US)

(21) Appl. No.: 15/179,796

(22) Filed: Jun. 10, 2016

Related U.S. Application Data
(63) Continuation of application No. 13/977,685, filed on Jun. 29, 2013, now abandoned.

(51) Int. Cl. H04L 29/08; H04L 12/28

(52) U.S. Cl. CPC H04L 67/125; H04L 12/2818; H04L 67/28

(57) ABSTRACT

A mechanism is described for facilitating proxy user interface-based remote management and control of computing devices according to one embodiment of the invention. A method of embodiments of the invention includes remotely pairing a first device with a second device, and remotely controlling the second device via a user interface provided at the first device. The user interface may serve as a proxy user interface at the first device for remotely controlling the second device. The first device may include a first computing device, and wherein the second device may include a second computing device or a second non-computing device.

### FIELD

The field relates generally to computing devices and, more particularly, to employing a mechanism for facilitating proxy user interface-based remote management and control of computing and non-computing devices.

### BACKGROUND

Conventional techniques require a person to be next to a computing and non-computing device or its control panel (such as that of a household appliance) and physically and manually control settings on the control panel. Furthermore, such control panels (e.g., Liquid Crystal Display (LCD) control panels) are typically small in size, and cumbersome and frustrating to navigate due to a limited number of options they offer.

### BRIEF DESCRIPTION OF THE DRAWINGS

Embodiments of the present invention are illustrated by way of example and not by way of limitation in the figures of the accompanying drawings, in which like references indicate similar elements and in which:

FIG. 1 illustrates a computing device employing a device control mechanism according to one embodiment of the invention;

FIG. 2 illustrates a device control mechanism according to one embodiment of the invention;

FIG. 3 illustrate protocol stack layers at computing and/or non-computing devices according to one embodiment of the invention;

FIG. 4A illustrates a method for facilitating proxy user interface-based remote management and control of computing and/or non-computing devices according to one embodiment of the invention;

FIG. 4B illustrates a method for facilitating proxy user interface-based remote management and control of computing and/or non-computing devices according to one embodiment of the invention; and

FIG. 5 illustrates a computing system according to one embodiment of the invention.

### DETAILED DESCRIPTION

Embodiments of the invention provide a mechanism for facilitating proxy user interface-based remote management and control of computing devices according to one embodiment of the invention. A method of embodiments of the invention includes remotely pairing a first device with a second device, and remotely controlling the second device via a user interface provided at the first device. The user interface may serve as a proxy user interface at the first device for remotely controlling the second device. The first device may include a first computing device, and wherein the second device may include a second computing device or a second non-computing device.

In one embodiment, a mechanism is disclosed for providing a proxy user interface, such as a touchscreen, that is network accessible, easy to use, and low cost. The solution facilitates a user computing device (e.g., a smartphone, a tablet computer, a laptop computer, a personal computer, etc.) to provide a user interface and act as proxy for intelligent and/or non-intelligent devices that the user wishes to monitor or control. In one embodiment, an intelligent device may include a computing device or a device having data processing or computational capabilities, such as a smartphone, a tablet computer, a laptop, a Personal Computer (PC), a smart camera (e.g., a closed-circuit camera, a personal camera, etc.), a Global Positioning System (GPS) navigation system, a smart consumer electronics device, such as a television, a DVD player, a Compact Disc (CD) player, an advanced security system, a set-top box, etc. In one embodiment, a non-intelligent device may include a non-computing device that lacks computer-like data processing capabilities, such as a non-smart cellphone, a non-smart household appliance, such as a refrigerator, an air-conditioning unit, a washer and dryer set, a dishwasher, a temperature control, a garage door, etc. For simplicity of terms, brevity, and ease of understanding, intelligent and/or non-intelligent devices may be individually and/or collectively referred to as “household device(s)” throughout this document.

This mechanism is efficient, low cost and can be easily incorporated in any number and type of intelligent and non-intelligent devices. In one embodiment, the mechanism is made compatible with existing and future standards, rules, and specification so that its enabling is easy and does not require the user to buy or install hardware and/or software, such as installing hardware accessories, downloading special drivers or software applications, etc. In one embodiment, the mechanism may further provide communication layers (e.g., wireless communication layers) relating to a wireless communication protocol that has built-in authentication and security so that an authenticated and verified computing device (that is to be managed and controlled) and the user computing device can connect and communication via the proxy user interface at the user computing device.

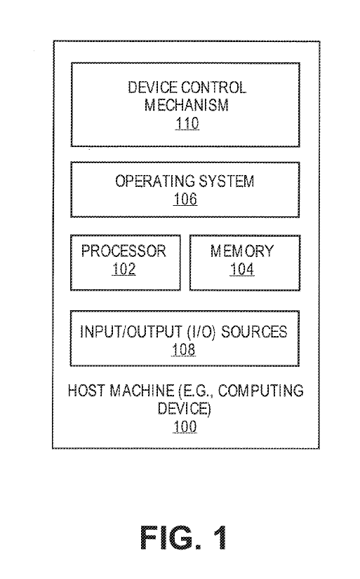

FIG. 1 illustrates a computing device employing a device control mechanism according to one embodiment of the invention. In one embodiment, a host machine (e.g., computing device) 100 is illustrated as having a device control mechanism (“control mechanism”) 110 includes a device control mechanism logic unit to facilitate dynamic pairing and remote controlling of computing devices and other functionalities as described throughout this document. Computing device 100 may include mobile computing devices, such as cellular phones including smartphones (e.g., iPhone®, BlackBerry®, etc.), handheld computing devices, personal digital assistants (PDAs), etc., tablet computers (e.g., iPad®, Samsung® Galaxy Tab®, etc.), laptop computers (e.g., notebook, netbook, ultrabook™, etc.), e-readers (e.g., Kindle®, Nook®, etc.), etc. Computing device 100 may further include set-top boxes (e.g., Internet-based cable television set-top boxes, etc.), and larger computing devices, such as desktop computers, server computers, cluster-based computers, etc. As aforementioned, mechanism 100, partially or in its entirety, may be employed at any combination of intelligent/computing devices (e.g., computing devices, consumer electronics devices, etc.) and non-intelligent/non-computing devices, such as household appliances or machines (e.g., kitchen appliances, garage doors, light panels, temperature control panels, etc.), and the like.

Computing device 100 includes an operating system 106 serving as an interface between any hardware or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “computing device”, “node”, “computing node”, “client”, “memory client”, “host”, “server”, “memory server”, “machine”, “device”, “computing device”, “computer”, “computing system”, “cluster based computer”, and the like, are used interchangeably and synonymously throughout this document.

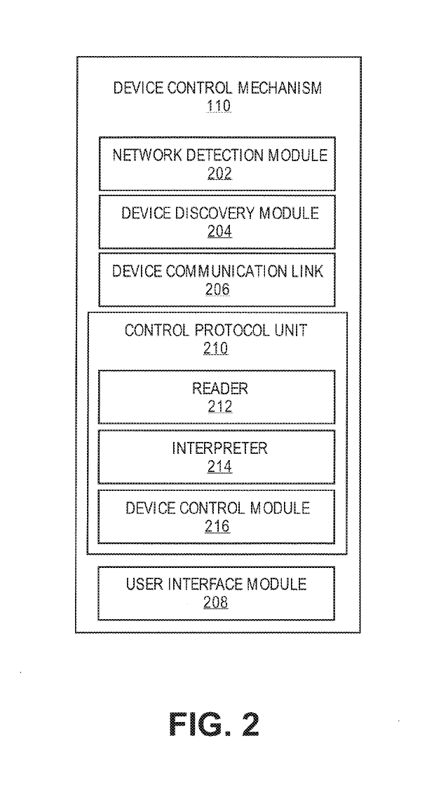

FIG. 2 illustrates a device control mechanism according to one embodiment of the invention. In one embodiment, device control mechanism 110 includes various components 202, 204, 206, 208, 210, 212, 214 and 216 to facilitate proxy user interface-based dynamic paring between two or more computing devices and remote controlling of one or more intelligent and non-intelligent devices using another computing device. For example and in one embodiment, a proxy user interface (e.g., a browser-like user interface) may be provided at a user's computing device (e.g., a smartphone, a personal computer, a tablet computer, a laptop, etc.) to be used by the user to remotely maintain and control an intelligent device, such as another computing device, and/or a non-intelligent device, such as household appliances, consumer electronics, etc. In one embodiment, the control mechanism 110 includes a network detection module 202 to detect an available network (e.g., Local Area Network (LAN), Personal Area Network (PAN), Bluetooth, etc.) to connect two or more devices. For example, a user computing device (e.g., a tablet computer) seeks to control a household device (e.g., a temperature control system) over a network (e.g. via the Bluetooth). In this case, the network detection module 202 may detect the Bluetooth connection between the user device and any number of household devices. As referenced above, it is contemplated that the term “household device” includes but is not limited to devices home devices, but that it also includes any number and type of intelligent/computing and non-intelligent/non-computing devices including, but not limited to, consumer appliances and electronics, etc., at offices, shops, theaters, automobiles, or even outdoors, and the like. For example, a garage door can be a house or office garage door and similarly, other examples may include a security system at a house, an air-temperature control system at a theater, a sound system in a car, an appliance (e.g., a stove, an oven, a dishwasher) in a kitchen in the house or at the office or simply a barbeque grill or a radio outdoors, etc.

Once the network is detected, in one embodiment, a device discovery module 204 may detect any number of household devices (e.g., a PC, a television, a stereo system, a temperature control system, a garage door system, a light switch control system, etc.) available to be selected by the user of the user computing device. Once the user selects a household device, a device communication link 206 connects and performs pairing of the user computing device with the household device using the available (selected) network.

In one embodiment, a user interface (UI) module 208 provides a user interface at the user computing device to serve as a proxy control panel for the selected household device. For example, the UI can provide various functionalities and setting options for the user not only to connect with and select any number of household devices, but also to manage and control the selected household devices, such as by manipulating its control panel via the proxy UI at the user computing device. In one embodiment, a UI provided by the UI module 208 at a user computing device may be used by the user to control and manage one or multiple household (intelligent and/or non-intelligent) devices. For example, a user may be provided a list of household devices via the UI and the user may select to control and manage one or more household devices from the list; for example, the user may select to turn on the television, turn of the dish-washer as well as the room lights, and set the security system prior to going to sleep. Stated differently, a single UI at a single computing device may be used to select, control, and manage any number and type of household intelligent and non-intelligent devices. In one embodiment, an account providing a UI may be assigned to each user (e.g., each household resident, each family member, etc.) to control and manage a single household device or any number of household devices based on, for example, pre-define properties or priorities or frequency of use, etc. For example, a single household device, such as a refrigerator, may be controlled and managed by each member of the entire family using their corresponding UI on their personal computing devices. However, given that multiple users can have access to a single household intelligent or non-intelligent device, certain priorities or properties may be set to provide some discipline and order in control and management of that single device. For example, the parents may access the television in the master bedroom, but the kids may not have such access. Similarly, all adult member of the family may have access to the refrigerator via their corresponding UI, but, for example, based on pre-assigned priorities, the mother in the house may have the highest priority (when, for example, the refrigerator is controlled or accessed simultaneously by other users), followed by the father, the older kids, the younger kids, and so forth.

The user may, for example, turn a switch on or off using the proxy UI and also change settings on the household device as frequently as desired or necessitated without having to physical touch or be next to the household device. Further, for example, users may request a deferred or future operation on household devices, such as set the heater to be turned off after a few hours, or program any number of household devices to function on a particular schedule, such as programming certain house lights to be turned on for a few hours each night when the family is out on vacation. Further, for example, using plug and play properties (e.g., of a Bluetooth device), the UI module 208 automatically provides a UI and UI-based facilities as soon as the user computing device is switched on to the Bluetooth and connects with the selected household device. For example, the UI may be based on another standard, such as World Wide Web Consortium (W3C)'s Hypertext Markup Language 5 (HTML5). HTML refers to a markup language that allows a low cost, low power computing device to encode a UI screen in American Standard Code for Information Interchange (ASCII) using tags, but the UI proxy may show rich graphics by interpreting the tags. Further, an HTML5-encoded page can be used to show a touchscreen UI for controlling a computing device or may contain hyperlinks for viewing instructions on the UI proxy. For example, HTML5 over Bluetooth may give the computing device manufacturer a great deal of flexibility and control over their design and implementation, such as offering small UIs that requires a small controller and non-volatile memory, or providing large UIs with sophisticated graphics, video, and/or audio, etc.

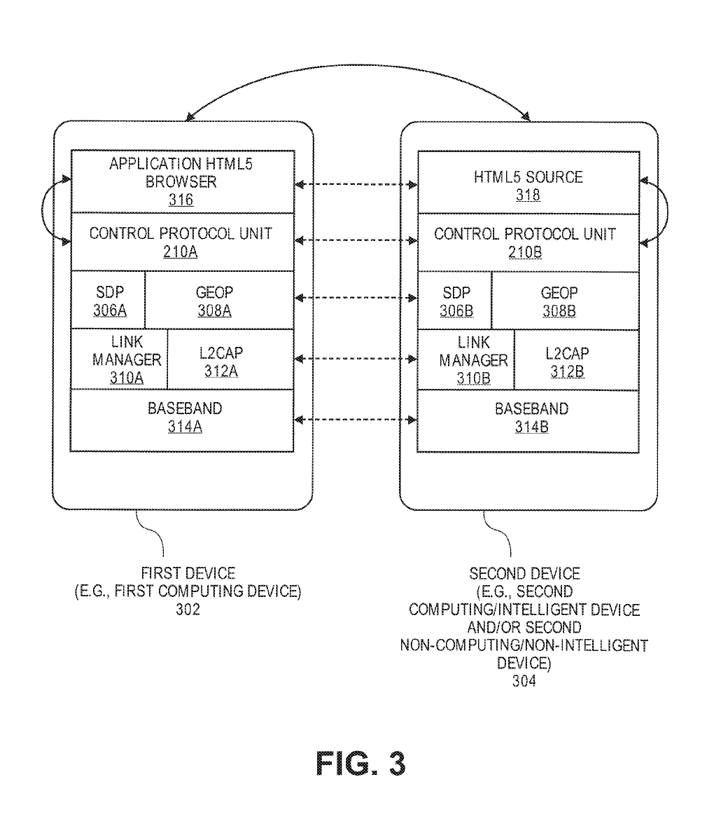

Once the discovery is performed and a communication link is established between two or more computing devices (e.g., between a user smartphone and a house security system, etc.), a control protocol unit 210 of the device control mechanism 110 is triggered. The control protocol unit 210 offers compatibility to perform various tasks using any given (e.g., existing or future) standards (e.g., HTML5, etc.) and networks (e.g., Bluetooth, the Internet, etc.). For example, as will be further shown in reference to FIG. 3, the control protocol unit 210 establishes and maintains communication between an HTML5 browser and an HTML5 source and various components of the control mechanism 110 to facilitate having the user device remotely manage and control any number of other devices via, for example, an HTML5 browser-based proxy user interface. In one embodiment, a reader 212 of the control protocol unit 210 is capable of reading any given code (e.g., HTML5 code from the source) so that the code can then be given to an interpreter 214 that interprets the code read by the reader 212. This interpretation of the code is then forwarded on to a device control module 216 which then facilitates a user device (e.g., a laptop) to serve as a proxy device in order to control (via the proxy UI) any number of other computing devices around the house, office, outdoors, etc.

In one embodiment, there can be a direct link between the two devices, such as between a user tablet computer and a house security system where the user can control the house security system from anywhere over the Bluetooth, a wireless Internet connection, or even a wired connection between the two devices. In another embodiment, there may be a third device instructing the main user device to control any number of other devices. Continuing with our example, let us suppose the user is traveling out of town and forgets the tablet computer at home. In this case, the user may access the tablet computer at home, via the Internet, using any number of other devices available to the user, such another tablet computer, a laptop, an office computer in another city, a computer at the hotel, a public personal computer (PC) in a public café, etc. For example, the user may establish a personal account using the control mechanism 100 that can be accessed via the Internet to provide the user another proxy UI to access the proxy UI at the tablet computer at home that can then be facilitated to control the house security system.

As aforementioned, the device control mechanism 110 is dynamically compatible with any number and type of user computing or intelligent household devices (e.g., a computing device, such as a personal computer, a tablet computer, a smartphone, a video game console, a digital audio player, a GPS navigation system, a consumer electronics appliance (e.g., a television, a DVD player, a sophisticated closed-circuit television camera system, any number and type of non-intelligent household devices (e.g., as stoves, ovens, refrigerators, laundry machines and dryers, garage doors, dishwashers, etc.), any number and type of control panels associated with various devices, such as a temperature control panel, a garage door opener, a sound system, a security system panel, etc.), network access providers (e.g., telecommunication companies, Internet service providers, etc.), currently known and future standards (e.g., Institute of Electrical and Electronics Engineers (IEEE) 802.11, HTML, HTML5, etc.), and the like, so that the control mechanism 110 can efficiently perform is functions as described throughout this document.

It is contemplated that any number and type of components may be added to and removed from the device control mechanism 110 to facilitate remote management and control of devices. For brevity, clarity, ease of understanding and to stay focused on the device control mechanism 110, many of the standard or known components, such as those of a computing device, are not shown or discussed here. It is contemplated that embodiments of the invention are not limited to any particular technology or standard and is dynamic enough to adopt and adapt to the changing technologies and standards.

FIG. 3 illustrates protocol stack layers at computing and/or non-computing devices according to one embodiment of the invention. In the illustrated embodiment, a first device (e.g., a computing device, such as a user tablet computer, a PC, a smartphone, etc.) 302 and a second device (e.g., an intelligent household device, such as a PC, a television, etc., or a non-intelligent household device, such as a refrigerator, a temperature control system, etc.) 302 are in communication with each other using the corresponding Bluetooth protocol stacks. As aforementioned, embodiments of the invention are not limited to the Bluetooth and that any type of network or access ranges can be used but, for brevity, clarity and ease of understanding, Bluetooth protocol stacks are illustrated here as an example. For the same reason, two computing devices 302, 304 are shown here as an example, but, as previously mentioned, embodiments of the invention are not limited to two devices and can employ any number and type of computing devices.

In the illustrated embodiment, the first device 302 employs a control protocol unit 210A that represents the control protocol unit 210 of FIG. 2. Similarly, the second device 304 employs a control protocol unit 210B that represents the control protocol unit 210 of FIG. 2.

In one embodiment, the first device 302 includes a browser (e.g., an application HTML5 browser) 316, which may look like or be similar to an Internet browser (e.g., Explorer®, Safari®, Chrome®, etc.), to provide the user of the first computing device 302 a proxy user interface to access and facilitate the functionalities of the control protocol unit 210A, such as managing and controlling the second computing device 304 via the proxy UI without have to touch or manipulated the second device 304 or any of its control buttons, such as on a control panel. The browser 316 may represent a proxy UI provided by the user interface module 208 of FIG. 2. Further, the control protocol unit 210A at the first device 302 remains in communication with the HTML5 browser 316 that represents the proxy UI to maintain communication with and control over the second device 304, over the Bluetooth, via the communication between various layers 306A, 306B, 308A, 308A, 310A, 310B, 312A, 312B, 314A, 314B of the two Bluetooth protocol stacks.

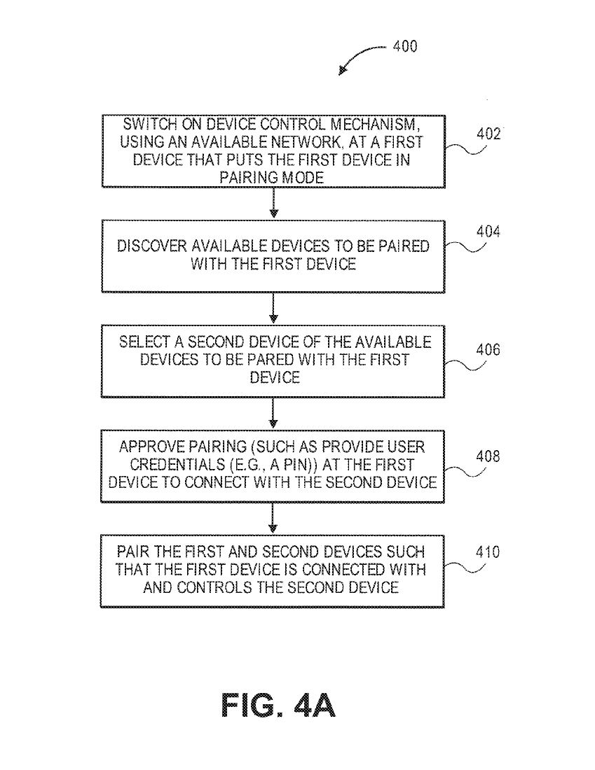

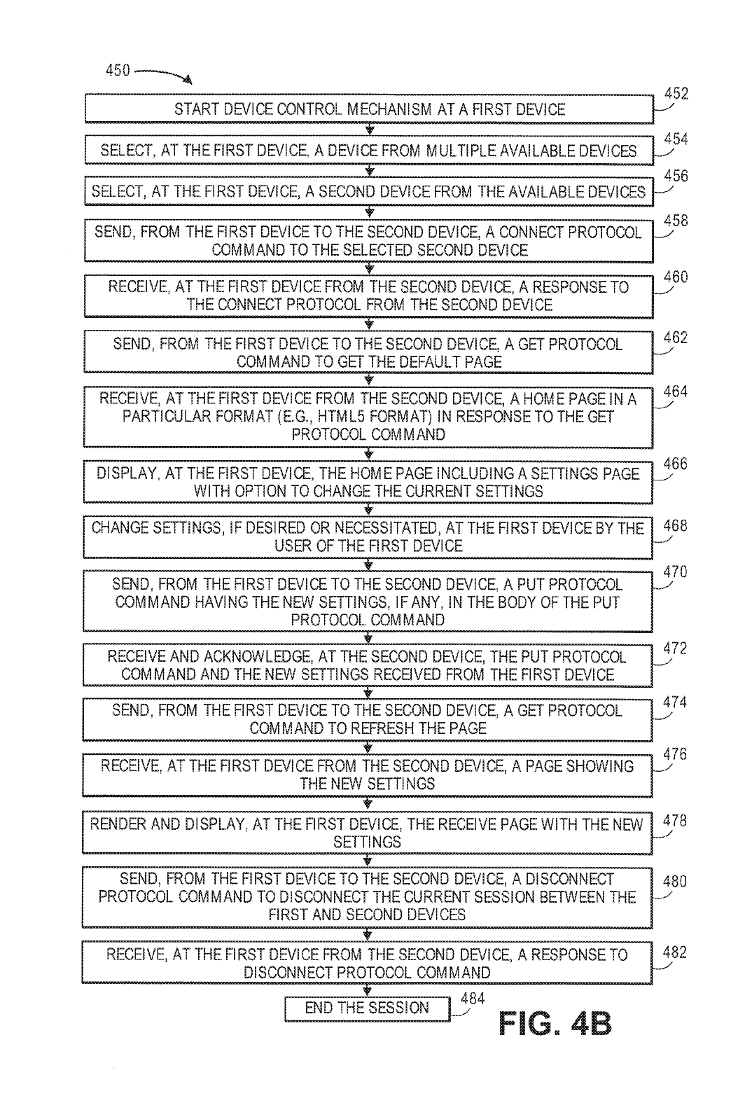

Similarly, at the second device 304, the control protocol unit 210B remains in communication with the source 318, such as HTML5 source (e.g., HTML5 code, HTML5 server logic or code, etc.). As was described with reference to the device control mechanism 110 of FIG. 2, the control protocol units 210A, 210B perform the task of reading the HTML5, interpreting it, and providing the communication and control between the two devices 302, 304. In the illustrated embodiment, various functions and operations facilitated by other components, such as components 202, 204, 206, of the device control mechanism 110 of FIG. 2 may be performed here by, for example, baseband layers 314A, 314B, link manager protocol (LMP) layers 310A, 310B, L2CAP layers 312A, 312B that include OSI layer 1 and 2 protocols in the Bluetooth stack. Service Discovery Protocol (SDP) layers 306A, 306B (as the device discovery module 204 of the device control mechanism 110 of FIG. 2) may allow the Bluetooth-enabled household devices, such as the second device 304, to be discovered. Generic Object Exchange Profile (GOEP) layers 308A, 308B represent a defined Bluetooth profile that is used to create reliable sessions between the two computing devices 302, 304. Further, for example, GOEP layers 308A, 308B may be used to exchange UI objects that are encoded in the HTML5 format using, for example, GET and PUT commands as will be described further with reference to FIG. 4B.

In one embodiment, once paired, the user, using the first device 302, can discover and connect the first device 302 with the second device 304 by simply switching on the Bluetooth on the first device 302. As aforementioned, embodiments of the invention are not limited to the two illustrated computing devices 302, 304 and that another one or more computing devices may be added to the two devices 302, 304. In one embodiment, the first device 302 may be used to manage and control any number of other intelligent or non-intelligent devices (e.g., a television, a first house garage door, a second house light switch, an office security system, a car sound system, an outdoor barbeque grill, etc.) in addition to the second device 304. In another embodiment, a user may use another device (e.g., another tablet computer, a smartphone, a public computer, a personal laptop, an office desktop, etc.) to control the first computing device 302, via the Internet, if, for example, the user is not in possession of the first computing device 302. For example, if the user is traveling, the user may use a smartphone to log into an access account to access the first device 302, over a network, such as the Internet, to remotely use the first device 302 to control and manage the second device 304. In other words, for example, the user's traveling device may be used to connected with the first device 302 over one network (e.g., Internet) to have the first device 302 control and manage the second device 304 over another network (e.g., Bluetooth).

FIG. 4A illustrates a method for facilitating proxy user interface-based remote management and control of computing and/or non-computing devices according to one embodiment of the invention. Method 400 may be performed by processing logic that may comprise hardware (e.g., circuitry, dedicated logic, programmable logic, etc.), software (such as instructions run on a processing device), or a combination thereof. In one embodiment, method 400 may be performed by the device control mechanism 110 of FIG. 1.

Method 400 starts at block 402 with a user switching on the device control mechanism at a first device (e.g., a computing device, such as a user smartphone, etc.) that puts the first device in pairing mode to be paired with one or more available second devices, such as intelligent/computing and/or non-intelligent/non-computing household devices (e.g., a television, a DVD player, a set-top box, a house security system, a temperature control system, etc.) over an available network (e.g., Bluetooth, the Internet, etc.). For example, the user may switch on the Bluetooth by pressing a button on the first/user computing device (e.g., smartphone) to search, over a network (e.g. Bluetooth), other Bluetooth-enabled household devices (e.g., a television, a refrigerator, etc.) that the user wishes to control. At block 404, the first device, using the device control mechanism, discovers the one or more available household devices.

At block 406, in one embodiment, a second device, such as the house temperature control, of the one or more available household devices is selected by the first device for pairing with the first device. At block 408, the pairing of the first and second devices is approved. The approval may include one or more processes, such as the user providing his or her credentials (e.g., a PIN, which may have been created by the user or hardcoded by the device manufacturer) at the first device for approval. At block 410, the first and second devices are paired up such that the first device, such as the user's smartphone, can be used by the user to maintain and control the second device, such as the user's house temperature control. It is contemplated that the word “user” may include a person or an end-user, such as a resident at a house controlling their household devices via the proxy UI, an employee controlling the office devices, etc.

In one embodiment, pairing may only need to be performed once and considered an optional process thereafter. For example, once a device is paired up with another device, there may not remain the need to pair the two already-paired devices again. Similarly, certain relationships or connections between two or more devices may be based on certain policies, preferences and/or predetermined criteria, such as based on particular users authorized to have access to particular devices, frequency of pairing between the same two or more devices, timing of paring, such as a particular time period may be assigned to a particular user to use or access a particular device, etc. It is contemplated that such policies, preferences, and criteria are dynamic and can be chanced as desired or necessitated.

FIG. 4B illustrates a method for facilitating proxy user interface-based remote management and control of computing and/or non-computing devices according to one embodiment of the invention. Method 450 may be performed by processing logic that may comprise hardware (e.g., circuitry, dedicated logic, programmable logic, etc.), software (such as instructions run on a processing device), or a combination thereof. In one embodiment, method 450 may be performed by the device control mechanism 110 of FIG. 1.

Method 450 begins at block 452 with the user staring the device control mechanism at a first device (e.g., first computing device) using, for example, an HTML5 browser that extends a user interface to the user. At block 454, multiple available computing devices may be prompted by the first device so that the user of the first device may select one or more of the available second devices (e.g., household devices, such as intelligent (computing) devices and/or non-intelligent (non-computing devices). At block 456, the user, using the first device, selects a second device from the available second computing devices. At block 458, the first device sends, for example, a CONNECT protocol command to connect to the selected second device. At block 460, the first device receives a response to the CONNECT protocol command from the second device. As aforementioned with reference to FIG. 4A, this process of blocks 458, 460 may be regarded as optional or unnecessary and performed merely once (when devices not in connected status).

Once the response is received at the first device, at block 462, the first device sends, for example, a GET protocol command with a Type Header set to the Multipurpose Internet Mail Extensions (MIME)-type of the HTML5 (e.g., x-obex/html5) to get the default or home page, such as an HTML5 browser-based default or home page that can be used to control the second device (e.g., changing of temperature control settings, etc.). At block 464, the first device receives from the second device, the default or home page in a particular format (e.g., HTML5 format) in response to the GET protocol command This home page (e.g., an HTML5 browser) may serve as the proxy user interface to manage and control the second device through or from the first device. At block 466, the first device displays the home page including a settings page with any number of options to change the current settings of the second device (e.g., security settings of a security control, temperature settings of a temperature control, timer settings of a light timer control, etc.). For example, at block 468, the user may use one of the options provided by the home page at his tablet computer (the first device) to turn the lights off at home by changing the current settings of the light timer control (the second device).

At block 470, the user, using the first device, submits the new settings by having the first device send, for example, a PUT protocol command with the body of the command containing the new settings. At block 472, the second device receives, acknowledges and accepts the PUT protocol command and the new settings received from the first device. At block 474, the second device sends, for example, a GET protocol command to the first device to refresh the browser page at the first device. At block 476, the GET protocol command along with the new browser page having the new settings is received or refreshed at the first device. At block 478, the first device renders and displays the received or refreshed browser home or another page, such as the aforementioned HTML5 browser-based default or home page, with the new settings. At block 480, the first device sends, for example, a DISCONNECT protocol command to disconnect the current session between the first device and the second device. At block 482, the first device receives a response to the DISCONNECT protocol command from the second device and, at block 484, the current session is terminated.

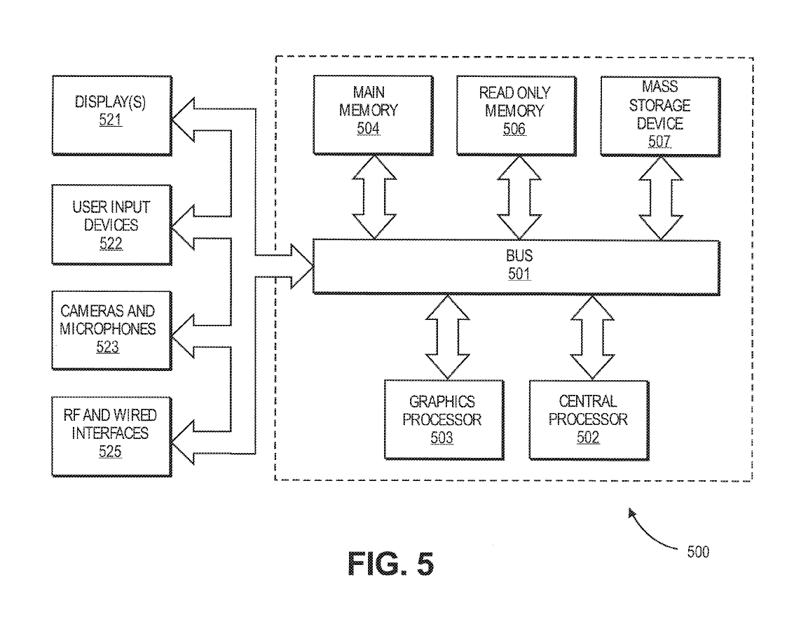

FIG. 5 illustrates a computing system 500 employing and facilitating a device control mechanism according to one embodiment of the invention. The exemplary computing system 500 may be the same as or similar to the computing device 100 FIG. 1 and any of the other computing devices discussed throughout this document, such as devices 302, 304 of FIG. 3. The computer system 500 includes a bus or a link or an interconnect (hereinafter referred to as “bus”) other communication means 501 for communicating information, and processing means such as a microprocessor 502 coupled with the bus 501 for processing information. The computer system 500 may be augmented with a graphics processor 503 for rendering graphics through parallel pipelines and may be incorporated into one or more central processor(s) 502 or provided as one or more separate processors.

The computer system 500 further includes a main memory 504, such as a RAM or other dynamic data storage device, coupled to the bus 501 for storing information and instructions to be executed by the processor 502. The main memory also may be used for storing temporary variables or other intermediate information during execution of instructions by the processor. The computer system 500 may also include a nonvolatile memory 506, such as a Read-Only Memory (ROM) or other static data storage device coupled to the bus 501 for storing static information and instructions for the processor.

A mass memory 507 such as a magnetic disk, optical disc, or solid state array and its corresponding drive may also be coupled to the bus 501 of the computer system 500 for storing information and instructions. The computer system 500 can also be coupled via the bus to a display device or monitor 521, such as a Liquid Crystal Display (LCD) or Organic Light Emitting Diode (OLED) array, for displaying information to a user. For example, graphical and textual indications of installation status, operations status and other information may be presented to the user on the display device 521, in addition to the various views and user interactions discussed above.

Typically, user input devices 522, such as a keyboard with alphanumeric, function and other keys, etc., may be coupled to the bus 501 for communicating information and command selections to the processor 502. Additional user input devices 522 may include a cursor control input device such as a mouse, a trackball, a trackpad, or cursor direction keys can be coupled to the bus for communicating direction information and command selections to the processor 502 and to control cursor movement on the display 521.

Camera and microphone arrays 523 may be coupled to the bus 501 to observe gestures, record audio and video and to receive visual and audio commands as mentioned above.

Communications interfaces 525 are also coupled to the bus 501. The communication interfaces may include a modem, a network interface card, or other well-known interface devices, such as those used for coupling to Ethernet, token ring, or other types of physical wired or wireless attachments for purposes of providing a communication link to support a LAN or Wide Area Network (WAN), for example. In this manner, the computer system 500 may also be coupled to a number of peripheral devices, other clients, or control surfaces or consoles, or servers via a conventional network infrastructure, including an Intranet or the Internet, for example. Examples of a network include, but are not limited to, a LAN, a WAN, a Metropolitan Area Network (MAN), a Personal Area Network (PAN), an intranet, the Internet, and the like. Embodiments may be implemented as any or a combination of: one or more microchips or integrated circuits interconnected using a parent-board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware, such as firmware.

Embodiments may be provided, for example, as a computer program product which may include one or more machine-readable media, such as a non-transitory machine-readable medium, having stored thereon machine-executable instructions that, when executed by one or more machines such as a computer, such as computing system 500, network of computers, or other electronic devices, may result in the one or more machines carrying out operations in accordance with embodiments of the present invention. A machine-readable medium may include, but is not limited to, floppy diskettes, optical disks, Compact Disc-ROMs (CD-ROMs), and magneto-optical disks, ROMs, RAMs, Erasable Programmable Read-Only Memories (EPROMs), EEPROMs Electrically Erasable Programmable Read-Only Memories (EEPROMs), magnetic or optical cards, flash memory, or other type of media/machine-readable medium suitable for storing machine-executable instructions, such as solid state storage devices, fast and reliable DRAM sub-systems, etc.

Program code, or instructions, may be stored in, for example, volatile and/or non-volatile memory, such as storage devices and/or an associated machine-readable or machine-accessible or machine-executable medium including solid-state memory, hard-drives, floppy-disks, optical storage, tapes, flash memory, memory sticks, digital video disks, DVDs, etc., as well as more exotic mediums such as machine-accessible biological state preserving storage. A machine-readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, smartphones, tablet computers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks or portions thereof may be performed by remote processing devices that are linked through a communications network.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. Embodiments of the invention are not limited by these specific examples. Numerous variations, whether explicitly given in the specification or not, such as differences in structure, dimension, and use of material, are possible. Embodiments may be at least as broad as given by the following claims.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer -readable transmission media (e.g., electrical, optical, acoustical or other form of propagated signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

In the foregoing specification, the invention has been described with reference to specific exemplary embodiments thereof. It will, however, be evident that various modifications and changes may be made thereto consistent with the description herein. The Specification and drawings are, accordingly, to be regarded in an illustrative rather than a restrictive sense.

1. An apparatus comprising:
a processor running on an operating system at a computing device, the operating system coupled to a dynamic control mechanism logic unit to perform remote controlling of computing devices, wherein the dynamic control mechanism logic unit comprises:
means for remotely pairing a first device with a second device, wherein the first device comprises a first computing device, and wherein the second device comprises a second computing device or a second non-computing device; and
means for remotely controlling the second device via a user interface provided at the first device, wherein the user interface serves as a proxy user interface at the first device for remotely controlling the second device.

2. The apparatus of claim 1, wherein the user interface comprises a browser-based user interface.

3. The apparatus of claim 1, wherein the dynamic control mechanism logic unit further comprises means for detecting a network including a wireless network.

4. The apparatus of claim 3, wherein the dynamic control mechanism logic unit further comprises:
means for automatically discovering a plurality of second devices; and
means for selecting the second device from the plurality of second devices.

5. The apparatus of claim 1, wherein the dynamic control mechanism logic unit further comprises:
means for reading software code associated with the browser, wherein the software code comprises a source;
means for interpreting the software code; and
based on the interpreted software code, establishing control of the second device by facilitating the user interface to serve as the proxy interface for remotely controlling the second device.

6. The apparatus of claim 5, wherein the dynamic control mechanism logic unit further comprises means for generating the user interface to serve as the proxy interface, wherein the dynamic control mechanism logic unit further comprises means for facilitating a communication link between first protocol stack layers of the first device and the second protocol stack layers of the second device.

7. (canceled)

8. The apparatus of claim 1, wherein the first computing device comprises one or more of a smartphone, a personal digital assistant (PDA), a handheld computer, an e-reader, a tablet computer, a notebook, a netbook, an ultrabook, a desktop computer, a server computer, a cluster-based computer, and a set-top box, wherein the second computing device comprises an intelligent device including a computing device or a consumer electronics device, and wherein the second non-computing device comprises a non-intelligent device including a household device or appliance.

9. (canceled)

10. (canceled)

11. (canceled)

12. (canceled)

13. (canceled)

14. (canceled)

15. (canceled)

16. (canceled)

17. A method comprising:
remotely pairing a first device with a second computing device, wherein the first device comprises a first computing device, and wherein the second device comprises a second computing device or a second non-computing device; and
remotely controlling the second device via a user interface provided at the first device, wherein the user interface serves as a proxy user interface at the first device for remotely controlling the second device.

18. The method of claim 17, wherein the user interface comprises a browser-based user interface.

19. The method of claim 17, further comprising detecting a network including a wireless network.

20. The method of claim 17, further comprising:
automatically discovering a plurality of second devices; and
selecting the second device from the plurality of second devices.

21. The method of claim 17, further comprising:
reading software code associated with the browser, wherein the software code comprises a source;
interpreting the software code; and
based on the interpreted software code, establishing control of the second device by facilitating the user interface to serve as the proxy interface for remotely controlling the second device.

22. The method of claim 21, further comprising generating the user interface to serve as the proxy interface.

23. The method of claim 17, further comprising facilitating a communication link between first protocol stack layers of the first device and the second protocol stack layers of the second device.

24. The method of claim 17, wherein the first computing device comprises one or more of a smartphone, a personal digital assistant (PDA), a handheld computer, an e-reader, a tablet computer, a notebook, a netbook, an ultrabook, a desktop computer, a server computer, a cluster-based computer, and a set-top box, wherein the second computing device comprises an intelligent device comprising a computing device or a consumer electronics device, and wherein the second non-computing device comprises a non-intelligent device comprising a household device or appliance.

25. (canceled)

26. (canceled)

27. At least one machine-readable medium comprising a plurality of instructions which, in response to being executed on a computing device, cause the computing device to carry out one or more operations comprising:
remotely pairing a first device with a second computing device, wherein the first device comprises a first computing device, and wherein the second device comprises a second computing device or a second non-computing device; and
remotely controlling the second device via a user interface provided at the first device, wherein the user interface serves as a proxy user interface at the first device for remotely controlling the second device.

28. The machine-readable medium of claim 27, wherein the one or more operations further comprise:
automatically discovering a plurality of second devices; and
selecting the second device from the plurality of second devices.
